(19) United States
(12) Patent Application Publication
(10) Pub. No.: US 2019/0330907 A1
(43) Pub. Date: Oct. 31, 2019

(54) POWER TAILGATE LIFT MECHANISM

(71) Applicant: Ford Global Technologies, LLC, Dearborn, MI (US)

(72) Inventors: Jack Marchlewski, Saline, MI (US); Joshua Robert Hemphill, White Lake, MI (US); Robert Reiners, Grosse Ile, MI (US); Dragan B. Stojkovic, Taylor, MI (US); Jeffrey Gray, Dearborn, MI (US)

(21) Appl. No.: 15/962,153

(22) Filed: Apr. 25, 2018

(51) Int. Cl. E05F 15/614; B62D 33/027

(52) U.S. Cl. CPC E05F 15/614; E05Y 2900/546; E05Y 2900/544; B62D 33/0273

(57) ABSTRACT

A tailgate for a motor vehicle is disclosed and includes an interior space accessible through a removable panel, a motor mounted within the interior space, and a drive mechanism driven by the motor for moving the tailgate about a pivot axis. The tailgate includes an overall height from the pivot axis and the motor is mounted a distance from the pivot axis.

### TECHNICAL FIELD

This disclosure relates to a tailgate lift mechanism that includes a motor mounted away from an axis of the tailgate and features simplifying assembly.

### BACKGROUND

Vehicles that includes a tailgate can be equipped with a lift mechanism to open and close the tailgate. The lift mechanism includes an electric motor mounted close to a pivot axis of the tailgate. The electric motor may be mounted within the static portion near the tailgate or within the tailgate. Motors that are mounted within the tailgate are positioned as close to the pivot axis as possible. Tailgates for pickup trucks includes lift aid features that are also positioned close to the pivot axis. Including an electric motor near a tailgate pivot axis introduces packaging constraints that can require design changes and that complicate assembly.

Automotive manufactures are continually seeking ways to improve vehicle operation, reduce cost and improve assembly while generating and maintaining consumer interest and loyalty.

### SUMMARY

A tailgate for a motor vehicle according to an exemplary aspect of the present disclosure includes, among other things, an interior space accessible through a removable panel, a motor mounted within the interior space, and a drive mechanism driven by the motor for moving the tailgate about a pivot axis. The tailgate includes an overall height from the pivot axis and the motor is mounted a distance from the pivot axis that is at least ½ the overall height.

In a further non-limiting embodiment of the foregoing tailgate for a motor vehicle, the motor is mounted a distance from the pivot axis that is at least ⅔ the overall height.

In a further non-limiting embodiment of an of the foregoing tailgates for a motor vehicle the drive mechanism comprises a pivot gear fixed about the pivot axis and a drive gear engaged to the pivot gear.

In a further non-limiting embodiment of any of the foregoing tailgates for a motor vehicle the drive gear is driven by one of a chain and toothed belt by a drive sprocket mounted to a rotating shaft of the motor.

In a further non-limiting embodiment of any of the foregoing tailgates for a motor vehicle an idler gear is disposed between the pivot gear and the drive sprocket for adjusting tension in the one of the chain and toothed belt.

In a further non-limiting embodiment of any of the foregoing tailgates for a motor vehicle a torsion rod is mounted within the interior space about the pivot axis and the pivot gear is mounted about the torsion rod.

In a further non-limiting embodiment of the foregoing tailgate for a motor vehicle the tailgate includes a reinforcement bracket attached to the tailgate and at least one of the pivot gear and idler gear is mounted to the reinforcement bracket.

In a further non-limiting embodiment of the foregoing tailgate for a motor vehicle, the reinforcement bracket and the drive mechanism are mounted outside of the interior space of the tailgate.

In a further non-limiting embodiment of the foregoing tailgate for a motor vehicle, including an inner support beam and the motor is mounted to the inner support beam.

In a further non-limiting embodiment of the foregoing tailgate for a motor vehicle, the pivot axis extends through the interior space of the tailgate at a bottom of the tailgate.

A tailgate lift mechanism according to another exemplary aspect of the present disclosure includes, among other things a motor mounted within an interior space of a tailgate, a reinforcement bracket attachable to an exterior portion of the tailgate, and a drive mechanism supported by the reinforcement bracket and driven by the motor for moving the tailgate about a pivot axis.

In a further non-limiting embodiment of the foregoing tailgate lift mechanism, the motor is mounted a distance from the pivot axis that is at least ⅔ the overall height.

In a further non-limiting embodiment of any of the foregoing tailgate lift mechanisms, the drive mechanism includes a pivot gear fixed to the reinforcement bracket and disposed about the pivot axis and a drive gear mounted to the reinforcement bracket engaged to the pivot gear.

In a further non-limiting embodiment of any of the foregoing tailgate lift mechanisms, the drive gear is driven through one of a chain and toothed belt by a drive sprocket mounted to a rotating shaft of the motor.

In a further non-limiting embodiment of any of the foregoing tailgate lift mechanisms, the interior space about the pivot axis and the pivot gear is mounted about the torsion rod.

A method of assembling a power tailgate lift mechanism according to another exemplary aspect of the present disclosure includes, among other things, inserting a motor through an opening covered by a removable panel into an interior space of the tailgate, mounting the motor within the interior space of the tailgate a distance from a pivot axis at least ⅔ an overall height of the tailgate, and mounting a drive mechanism to the tailgate that is devein by the motor for moving the tailgate between open and closed positions.

In a further non-limiting embodiment of any of the foregoing methods, the drive mechanism is mounted to a reinforcement bracket and the reinforcement bracket is mounted to an external surface of the tailgate.

In a further non-limiting embodiment of any of the foregoing methods, including fixing a pivot gear to the reinforcement bracket about a pivot axis of the tailgate, mounting a lower drive gear for rotation about the pivot gear on the reinforcement bracket, mounting an upper a drive gear that is driven by the motor to the reinforcement bracket and coupling the upper drive gear to the lower drive gear with an elongated drive member.

In a further non-limiting embodiment of any of the foregoing methods, the drive mechanism is mounted to the reinforcement bracket before the reinforcement bracket is attached to the tailgate.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a perspective view of an example vehicle tailgate.

FIG. 2 is a perspective view of a lift mechanism for the vehicle tailgate.

FIG. 3 is a perspective view of a portion of an example tailgate lift mechanism.

FIG. 4 is a schematic view of a portion of an example tailgate.

FIG. 5 is an enlarged view of a portion of the example tailgate lift mechanism.

FIG. 6 is a perspective view of an assembly step of the example lift mechanism.

FIG. 7 is a perspective view of a motor being installed within an interior space of a tailgate.

FIG. 8 is another perspective view of a motor being installed within an interior space in the example vehicle tailgate.

### DETAILED DESCRIPTION

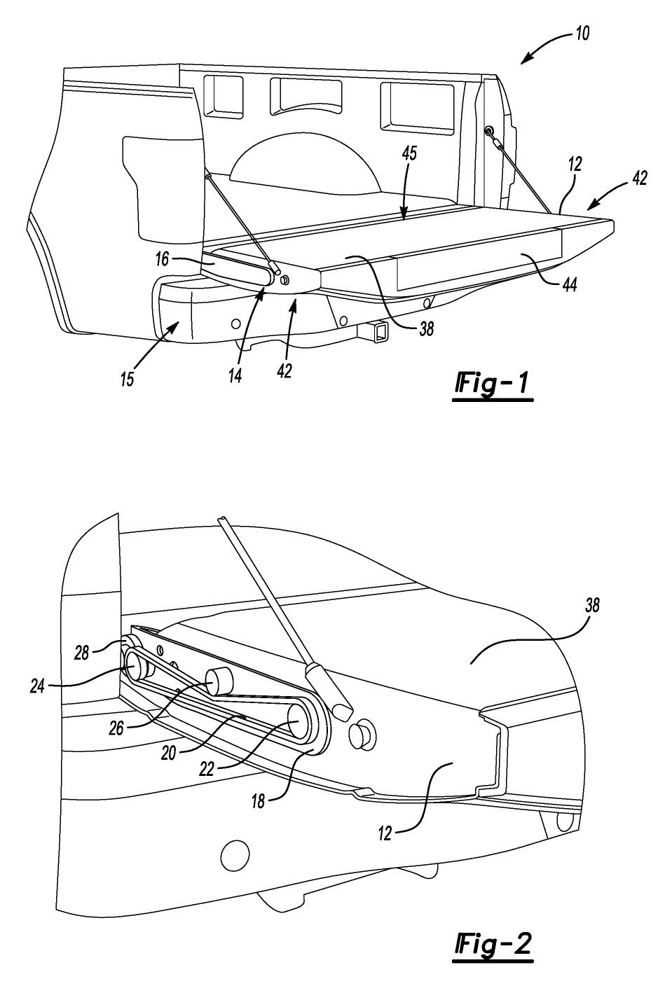

Referring to FIG. 1 an example vehicle 10 includes a tailgate 12 with a lift mechanism 15. Lift mechanism 15 is assembled to the vehicle tailgate 12 to move the tailgate 12 between an open and closed position. The tailgate 12 is illustrated in an open position in FIG. 1. The tailgate 12 includes sides 42, a top 44, and a bottom 45. A removable panel 38 in the tailgate 12 provides access to an interior space 35. A drive mechanism 14 of the lift mechanism 15 is mounted to a side 42 of the lift tailgate 12 and is protected by a cover 16.

Referring to FIG. 2 with continued reference to FIG. 1 the example lift mechanism 14 is illustrated without the cover 16 and includes a bracket 18 that is attached to the side 42 of the tailgate 12. The bracket 18 supports an upper drive gear 22 and a lower drive gear 24. Bracket 18 also supports an idle gear 26 that is disposed between the upper drive gear 22 and the lower drive gear 24. A toothed belt 20 couples the upper drive gear 22 to the lower drive gear 24. The idle gear 26 maintains a predefined tension on the belt 20. It should be appreciated that although a belt 20 is illustrated by way of example, that a chain or any other elongated member for transmitting torque between spaced apart gears could be utilized and is within the contemplation and scope of this disclosure.

The lower drive gear 24 is engaged to a pivot gear 28. The pivot gear 28 is fixed to the bracket 18 and not rotatable. Rotation of the lower drive gear 24 causes the drive mechanism to rotate about the fixed pivot gear 28 to move the tailgate 12.

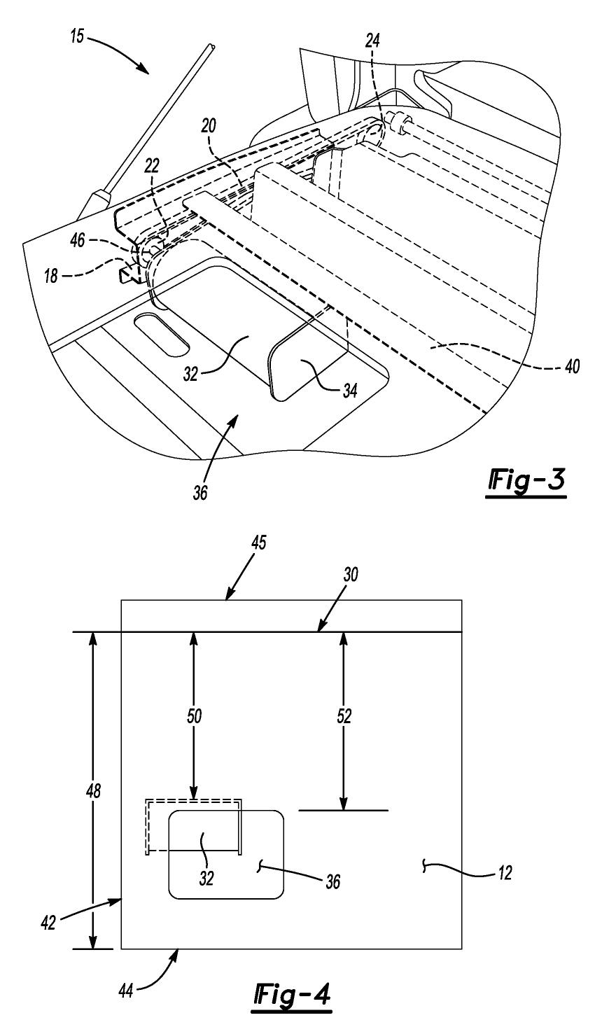

Referring to FIG. 3 with continued reference to FIG. 2, the upper drive gear 22 is driven by a motor 32 that is disposed within the interior space 35 of the tailgate 12. The example motor 32 is mounted on a motor bracket 34 which is in turn mounted to a stiffening beam 40 of the tailgate 12. The motor 32 is assembled and mounted to the beam 40 through the opening 36 covered by the access panel 38. The motor 32 includes a shaft 46 that extends out through the side 42 of the tailgate 12 and attaches to the upper drive gear 22. Rotation of the motor 32 drives the upper drive gear 22 that is coupled to the lower drive gear 24.

Referring to FIG. 4 with continued reference to FIG. 3, the example motor 32 is mounted within the tailgate 12 and is positioned a distance 50 from the pivot axis 30. The opening 36 is provided at a distance 52 from the pivot axis 30. An overall height 48 of the tailgate 12 is defined between the pivot axis 30 and the top 44.

The distance 50, in one disclosed embodiment, is at least one half of the height 48. In another disclosed embodiment the distance 50 is at least two-thirds of the height 48. Moreover, the distance 52 between the pivot axis 30 and the opening 36 is also, in one disclosed embodiment, at least one-half the height 48. Accordingly the motor 32 is spaced apart a distance from the pivot access 30 to enable features and structures of the tailgate 12 that facilitate operation and removal of the tailgate 12 to remain substantially unchanged.

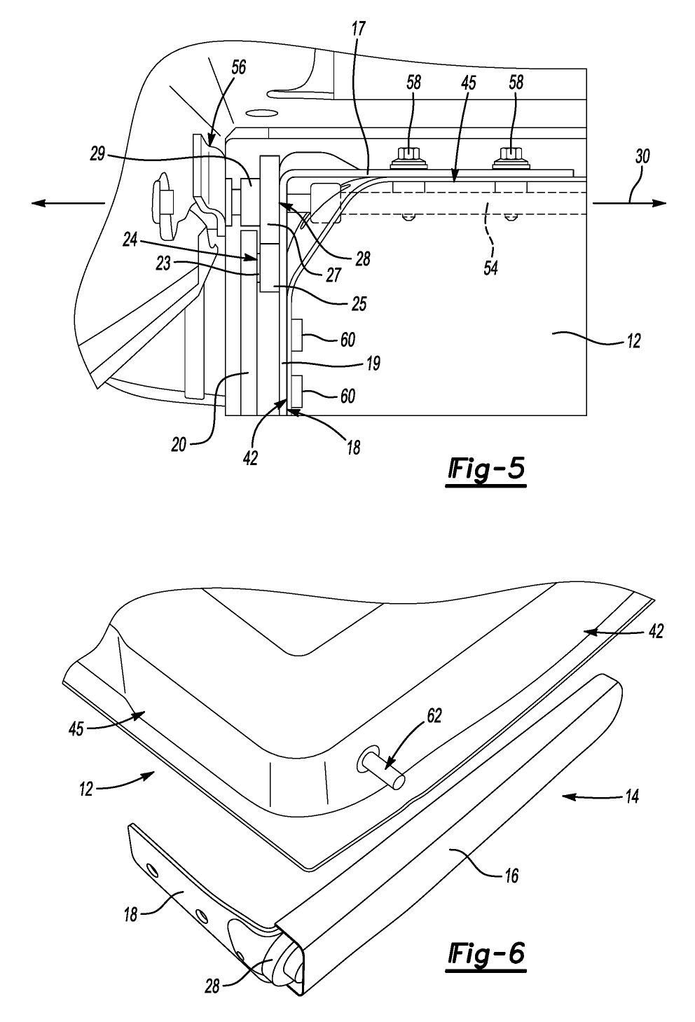

Referring to FIG. 5 with continued reference to FIGS. 3 and 4, the tailgate 12 includes a torque shaft 54 that is disposed along the pivot access 30. The torque shaft 54 aids in moving the tailgate 12 from the closed position. The example torque shaft 54 is attached to a bottom 45 of the tailgate 12 by way of fasteners 58. The same fasteners 58 are utilized to secure the bracket 18 to the tailgate 12. The example bracket 18 includes a lower portion 17 that is attached to the bottom portion 45 of the tailgate 12. The bracket 18 further includes an upper portion 19 that is secured to the side 42 of the tailgate 12 by fasteners 60. The fasteners 60 extend through the interior volume 35 of the tailgate and secure the bracket 18.

The example pivot gear 28 includes a first large portion 27 and a second smaller portion 29. The large portion 27 includes gear teeth that are in engagement to a portion of the lower drive gear 24. The upper portion 29 is smaller and is disposed about the pivot access 30 and the torque shaft 54. Pivot gear 28 is not attached to the torque shaft 54 but it is fixed to the bracket 18 such that it does not rotate relative to the bracket 18. Lower drive gear 20 is not fixed to the bracket 18 but is secured in a fashion that enables rotation. Accordingly, rotation of the drive gear 24 coupled to the fixed pivot gear 28 enables rotation of the tailgate 12 about the axis 30.

The example drive gear 24 includes a first portion 23 that is engaged to the drive belt 20 and a second portion 25 that is engaged to the pivot gear 28. A difference in diameter between the first portion 23 and the second portion 25 provides a gear ratio determined to provide sufficient torque and power to move the tailgate 12 at a desired speed between the open and closed position.

The torque shaft 54 includes an end 62 that is secured to a fixed portion of the vehicle schematically indicated at 56. The torque shaft 54 defines the pivot axis 30 about which the tailgate 12 is rotated.

Accordingly, the example drive mechanism 14 is mountable to exterior surfaces of the tailgate 12 and therefore does not require significant modification to the tailgate 12 to enable assembly of the lift mechanism 15.

Referring to FIG. 6 a method of assembling the example power lift mechanism 15 is schematically shown and begins with assembly of the drive mechanism 14 to the tailgate 12. Assembly of the drive mechanism 14 is facilitated by attaching the bracket 18 to a bottom 45 of the tailgate 12. The bracket 18 is secured by way of threaded fasteners 58 to the bottom side 45 and secured to the side 42 with fasteners 60. Drive mechanism 14 is aligned such that the pivot gear 28 is exposed about an end of the torque shaft 54. The remainder of the bracket 18 extends along the side 42 to a position where the upper drive gear 22 may be coupled to a shaft of the motor.

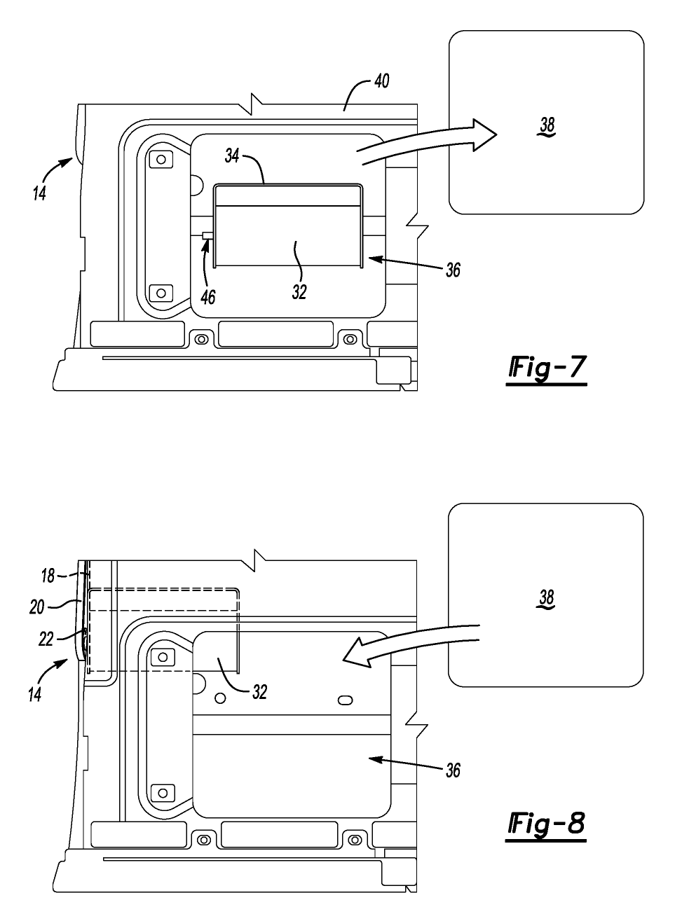

Referring to FIG. 7 with continued reference to FIG. 6, the method continues by assembling a motor 32 into the interior space 35 of the tailgate 12 through the opening 36. The opening 36 is accessible by removal of the panel 38.

The motor 32 is inserted through the opening 36 and mounted to the beam 40. In this example the motor 32 is mounted to the motor bracket 34 that is in turn secured to the beam 40. It should be appreciated that other mounting configurations for the motor are within the contemplation of this disclosure. The motor 32 is secured to the beam 40 such that the motor shaft 46 will engage the upper drive gear 22 of the drive mechanism 14 previously assembled to the outer side of the tailgate 12.

Referring to FIG. 8 with continued reference to FIGS. 6 and 7, the example motor 32 is shown assembled within the interior space 35 of the tailgate 12 such that the motor shaft 46 is engaged to the upper drive gear 22. Once the motor 32 is assembled and secured within the interior space 35 of the tailgate 12 the panel 38 may be reassembled over the opening 36.

Control of the motor 32 is provided by a vehicle controller through an electrical connection (not shown) to a vehicle wire harness. The control and operation of the motor 32 may be automatic between the open and closed positions, or may be manually operated. Both modes of operation as well as others within the knowledge of one skilled in the art are within the scope and contemplation of this disclosure.

The example disclosed lift mechanism 15 enables assembly to an existing tailgate 12 without significant modification by mounting the motor 32 in a position that is spaced apart from the tailgate pivot access 30. Moreover, the drive mechanism 14 is mountable by way of the bracket 18 to an exterior surface of the tailgate 12 to further simplify and ease assembly.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A tailgate for motor vehicle comprising:
an interior space accessible through a removable panel;
a motor mounted within the interior space; and
a drive mechanism driven by the motor for moving the tailgate about a pivot axis, wherein the tailgate includes an overall height from the pivot axis and the motor is mounted a distance from the pivot axis that is at least ½ the overall height.

2. The tailgate as recited in claim 1, wherein the motor is mounted a distance from the pivot axis that is at least ⅔ the overall height.

3. The tailgate as recited in claim 1, wherein the drive mechanism comprises a pivot gear fixed about the pivot axis and a drive gear engaged to the pivot gear.

4. The tailgate as recited in claim 3, wherein the drive gear is driven by one of a chain and toothed belt by a drive sprocket mounted to a rotating shaft of the motor.

5. The tailgate as recited in claim 4, including an idler gear disposed between the pivot gear and the drive sprocket for adjusting tension in the one of the chain and toothed belt.

6. The tailgate as recited in claim 3, including a torsion rod mounted within the interior space about the pivot axis and the pivot gear is mounted about the torsion rod.

7. The tailgate as recited in claim 5, wherein the tailgate includes a reinforcement bracket attached to the tailgate and at least one of the pivot gear and idler gear is mounted to the reinforcement bracket.

8. The tailgate as recited in claim 7, wherein the reinforcement bracket and the drive mechanism are mounted outside of the interior space of the tailgate.

9. The tailgate as recited in claim 1, wherein the tailgate includes an inner support beam and the motor is mounted to the inner support beam.

10. The tailgate as recited in claim 1, wherein the removable panel covers an opening including a portion that is spaced a distance from the pivot axis that is at least ½ the overall height of the tailgate.

11. The tailgate as recited in claim 1, wherein the pivot axis extends through the interior space of the tailgate at a bottom of the tailgate.

12. A tailgate lift mechanism comprising:
a motor mounted within an interior space of a tailgate;
a reinforcement bracket attachable to an exterior portion of the tailgate; and
a drive mechanism supported by the reinforcement bracket and driven by the motor for moving the tailgate about a pivot axis.

13. The power tailgate lift mechanism as recited in claim 12, wherein the motor is mounted a distance from the pivot axis that is at least ⅔ the overall height.

14. The power tailgate lift mechanism as recited in claim 12, wherein the drive mechanism includes a pivot gear fixed to the reinforcement bracket and disposed about the pivot axis and a drive gear mounted to the reinforcement bracket engaged to the pivot gear.

15. The power tailgate lift mechanism as recited in claim 14, wherein the drive gear is driven through one of a chain and toothed belt by a drive sprocket mounted to a rotating shaft of the motor.

16. The power tailgate lift mechanism as recited in claim 15, including a torsion rod mounted within the interior space about the pivot axis and the pivot gear is mounted about the torsion rod.

17. A method of assembling a power tailgate lift mechanism comprising:
inserting a motor through an opening covered by a removable panel into an interior space of the tailgate;
mounting the motor within the interior space of the tailgate a distance from a pivot axis at least ⅔ an overall height of the tailgate; and
mounting a drive mechanism to the tailgate driven by the motor for moving the tailgate between open and closed positions.

18. The method as recited in claim 17, including mounting the drive mechanism to a reinforcement bracket and mounting the reinforcement bracket to an external surface of the tailgate.

19. The method as recited in claim 18, including fixing a pivot gear to the reinforcement bracket about a pivot axis of the tailgate, mounting a lower drive gear for rotation about the pivot gear on the reinforcement bracket, mounting an upper a drive gear that is driven by the motor to the reinforcement bracket and coupling the upper drive gear to the lower drive gear with an elongated drive member.

20. The method as recited in claim 19, wherein the drive mechanism is mounted to the reinforcement bracket before the reinforcement bracket is attached to the tailgate.
